(19) United States
(12) Patent Application Publication
(10) Pub. No.: US 2018/0057052 A1
(43) Pub. Date: Mar. 1, 2018

(54) TRAILER ANGLE MEASUREMENT FOR AUTOMATED MANEUVERING

(71) Applicant: Eaton Corporation, Cleveland, OH (US)

(72) Inventors: Conor Haas Dodd, Kalamazoo, MI (US); Matt Boillat, Scotts, MI (US); Jon Steeby, Schoolcraft, MI (US); Stephanie F. Lee, Ashland, MA (US)

(73) Assignee: Eaton Corporation, Cleveland, OH (US)

(21) Appl. No.: 15/686,540

(22) Filed: Aug. 25, 2017

Related U.S. Application Data
(60) Provisional application No. 62/379,731, filed on Aug. 25, 2016.

(51) Int. Cl. B62D 15/02; B62D 13/02; B62D 63/08; G01D 5/16

(52) U.S. Cl. CPC B62D 15/023; B62D 13/025; B62D 53/08; G01D 5/16; B62D 63/08

(57) ABSTRACT

A trailer angle measurement assembly that measures an angle of a trailer relative to a tractor includes a mounting base, an armature, a roller wheel and a rotary encoder. The mounting base is configured to be selectively coupled to the trailer. The armature is rotatable coupled to the mounting base around a pivot. The roller wheel is rotatably coupled to the armature and is positioned for rotatable engagement with the trailer. The rotary encoder measures rotation of the roller wheel and generates a signal based on the measured rotation indicative of an angular position of the trailer relative to the tractor.

### CROSS-REFERENCE TO RELATED APPLICATIONS

This application claims the benefit of U.S. Patent Application No. 62/379,731 filed on Aug. 25, 2016. The disclosure of the above application is incorporated herein by reference.

### FIELD

The present disclosure relates generally to vehicles towing a trailer and more specifically to a trailer angle measurement assembly and related method.

### BACKGROUND

Various heavy and medium duty trucks or truck tractors exist that are configured to tow corresponding semi-trailers. The term “tractor” as used herein refers to any truck vehicle which tows an attached vehicle. It therefore includes trucks and truck tractors. It also includes trailers which are equipped to tow other trailers. The term “trailer” as used herein refers to a towed truck vehicle and includes full truck trailers and truck semi-trailers. It will be appreciated that while the following discussion is directed toward tractors and semi-trailers, the same may be applied to other vehicles that tow a trailer.

In many scenarios, a tractor operator is required to direct the trailer into a desired location such as a loading dock while operating the tractor in a reverse gear. In some examples it can be difficult to determine the angle of the trailer relative to the tractor during such operations. It would be desirable to identify the angle of the trailer relative to the tractor during such maneuvering while the vehicle operator is in control of the tractor. It would further be desirable to identify the angle of the trailer relative to the tractor in real time and with sub-degree resolution during autonomous low-speed truck trailer maneuvering.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A trailer angle measurement assembly that measures an angle of a trailer relative to a tractor includes a mounting base, an armature, a roller wheel and a rotary encoder. The mounting base is configured to be selectively coupled to the trailer. The armature is rotatable coupled to the mounting base around a pivot. The roller wheel is rotatably coupled to the armature and is positioned for rotatable engagement with the trailer. The rotary encoder measures rotation of the roller wheel and generates a signal based on the measured rotation indicative of an angular position of the trailer relative to the tractor.

According to additional features, the trailer angle measurement assembly further includes a biasing member that biases the armature toward the trailer. The biasing member is one of a coil spring and a leaf spring. The roller wheel can be rotatably coupled to a hub of the armature. The mounting base can be coupled to a fifth wheel of the trailer. The mounting base can be magnetically coupled to the fifth wheel. The mounting base can be coupled at a forward mounting location of the fifth wheel. The mounting base can be coupled at a side mounting location of the fifth wheel. A control system includes a controller that receives the signal from the rotary encoder.

A trailer angle measurement assembly that measures an angle of a trailer relative to a tractor according to another example of the present disclosure includes a mounting base, an armature, a roller wheel and a potentiometer. The mounting base can be configured to be selectively coupled to the trailer. The armature is rotatably coupled to the mounting base around a pivot. The roller wheel is rotatably coupled to the armature and is positioned for rotatable engagement with the trailer. The potentiometer can be configured to measure rotation of the roller wheel and generate a signal based on the measured rotation indicative of an angular position of the trailer relative to the tractor.

According to additional features, the trailer angle measurement assembly further includes a biasing member that biases the armature toward the trailer. The biasing member is one of a coil spring and a leaf spring. The roller wheel can be rotatably coupled to a hub of the armature. The mounting base can be coupled to a fifth wheel of the trailer. The mounting base can be magnetically coupled to the fifth wheel. The mounting base can be coupled at a forward mounting location of the fifth wheel. The mounting base can be coupled at a side mounting location of the fifth wheel. A control system includes a controller that receives the signal from the potentiometer.

A method of determining an angular position of a trailer relative to a tractor includes rotatably mounting a roller wheel relative to the tractor. The roller wheel is positioned into rotatable engagement with the trailer. A rotation of the roller wheel is measured based on the roller wheel rotating from engagement with the trailer. An angular position of the trailer relative to the tractor is determined based on the measured rotation.

In other features, rotatably mounting the roller wheel relative to the tractor includes magnetically coupling a mounting base to the tractor. The roller wheel is coupled to the mounting base through an armature. Magnetically coupling the mounting base to the tractor includes coupling the mounting base to a fifth wheel of the tractor.

A trailer angle measurement assembly that measures an angle of a trailer relative to a tractor according to another example of the present disclosure includes a first left trailer wheel speed sensor configured to determine a first left wheel speed of the trailer. A first right trailer wheel speed sensor is configured to determine a first right wheel speed of the trailer. A first left tractor wheel speed sensor is configured to determine a first left wheel speed of the tractor. A first right tractor wheel speed sensor configured to determine a first right wheel speed of the tractor. A controller determines a trailer angle based on at least one of (i) the first left and right trailer wheel speeds and (ii) the first left and right tractor wheel speeds. The controller determines a current steering angle and communicates a signal based on a comparison between the current steering angle and a maximum allowable steering angle.

A trailer angle measurement assembly that measures an angle of a trailer relative to a tractor according to another example of the present disclosure includes an imaging device and a controller. The imaging device is coupled to one of the tractor and trailer and is configured to send and receive light, sound and/or image data. The controller determines a trailer angle based on input from the imaging device. The imaging device can be a camera. In another example, the imaging device can be a Lidar device. The Lidar device can measure a distance between the tractor and the trailer by illuminating the trailer with pulsed light and measuring the reflected pulses.

### BRIEF DESCRIPTION OF THE DRAWINGS

The present disclosure will become more fully understood from the detailed description and the accompanying drawings, wherein:

FIG. 1 is a schematic illustration of an exemplary tractor and trailer in which the trailer measurement assembly of the present disclosure may be utilized;

FIG. 2 is a side view of a trailer angle measurement assembly constructed in accordance to one example of the present disclosure;

FIG. 3 is a top view of the trailer angle measurement assembly of FIG. 2 mounted at various locations on a fifth wheel of a tractor according to various examples of the present disclosure;

FIG. 4 is an exemplary control system configured for use with the trailer angle measurement assembly of FIG. 2;

FIG. 5 is a top view of an exemplary tractor and trailer incorporating a trailer angle measurement assembly that includes trailer angle and trajectory prediction according to another example of the present disclosure;

FIG. 6 is an exemplary control system configured for use with the trailer angle measurement assembly of FIG. 5;

FIG. 7 is a top view of an exemplary tractor and trailer incorporating a trailer angle measurement assembly that utilizes a camera and/or light detection and ranging (LIDAR) according to another example of the present disclosure; and

FIG. 8 is an exemplary control system configured for use with the trailer angle measurement assembly of FIG. 7.

### DETAILED DESCRIPTION

With initial reference to FIGS. 1-3, an exemplary trailer angle measurement assembly constructed in accordance to one example of the present disclosure is shown and generally identified with reference numeral 10. The exemplary trailer angle measurement assembly 10 can be particularly suitable for application in a medium-duty or heavy-duty truck. However, the present teachings may be adapted for use in other vehicles. In the exemplary illustration in FIG. 1, the trailer angle measurement assembly 10 is mounted for use in a vehicle 20 having a tractor 22 and a semi-trailer 24. The semi-trailer 24 is selectively coupled to the tractor 22 by a connecting assembly 26 which comprises a fifth wheel 30 fixed to the tractor 22 for selective engagement with a king pin fixed to the semi-trailer 24. The tractor 22 typically comprises a pair or tandem set of rear drive axles 36, 38 and a front steer axle 40. The trailer 24 typically comprises a tandem set or pair of non-steerable non-driven trailer axles 42 and 44. Typically, but not necessarily, the front steer axle 40 is non-driven and steerable. Again, it will be appreciated that the configuration of the vehicle 20 is merely exemplary and the present teachings may be applied to any vehicle that pulls and/or pushes a trailer.

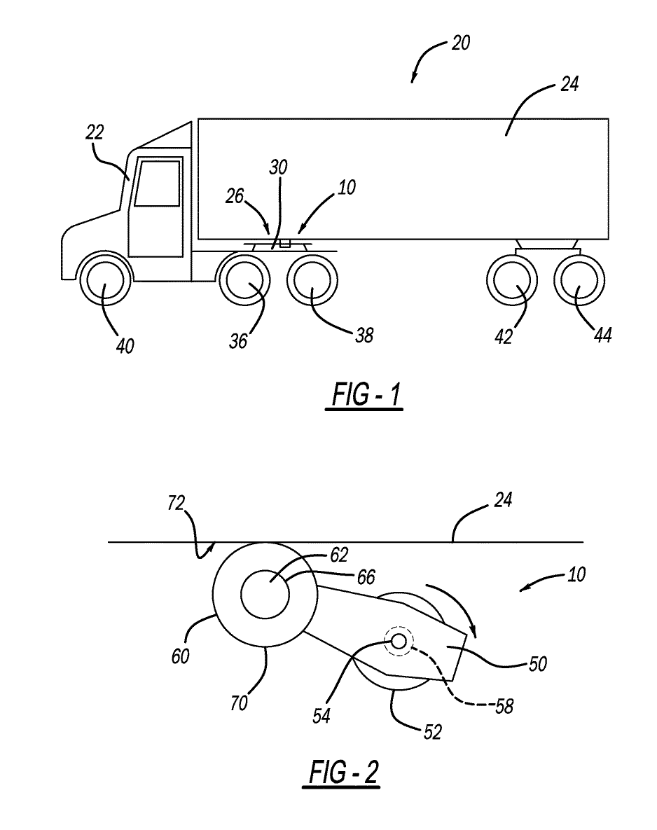

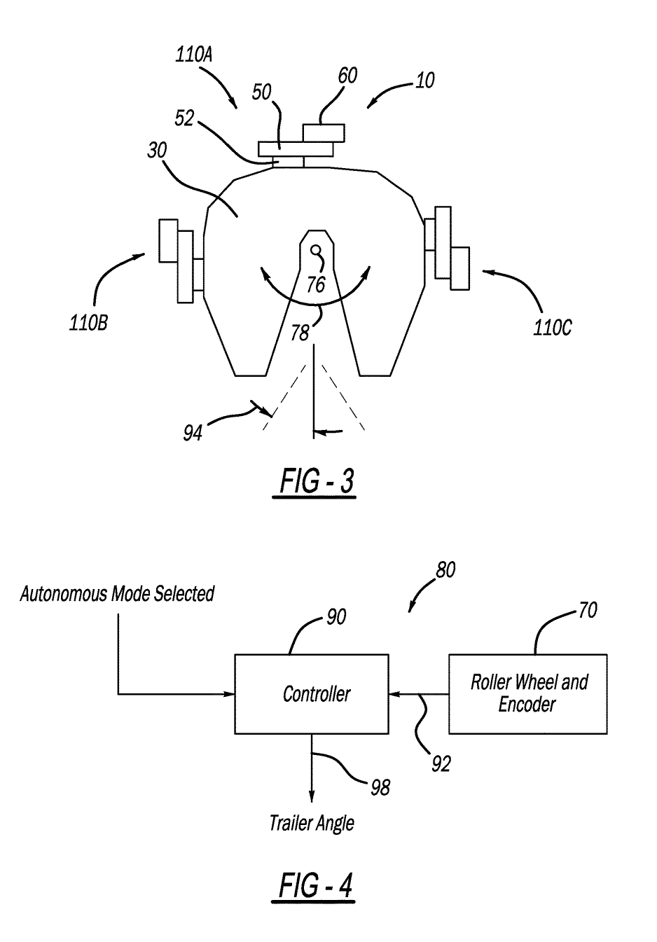

With particular reference to FIGS. 2 and 3, the trailer angle measurement assembly 10 will be further described. The trailer angle measurement assembly 10 can include an armature 50 rotatably coupled to a mounting base 52. The armature 50 rotates around a pivot 54. A biasing member 58 biases the armature 50 toward the semi-trailer 24, or in a direction clockwise as viewed in FIG. 2. A roller wheel 60 is rotatably coupled to a hub 62 of the armature 50. The biasing member 58 can be a spring such as a coil spring or leaf spring or other member configured to urge the roller wheel 60 into engagement with the semi-trailer 24. As can be appreciated, the spring loaded armature 50 allows the roller wheel 60 to move up and down to facilitate positioning of the roller wheel 60 into contact with the semi-trailer 24. The hub 62 can comprise at least one of a multi-turn potentiometer or rotary encoder 66. By way of non-limiting example, the multi-turn potentiometer can be a three-terminal resistor with a sliding or rotating contact that forms an adjustable voltage divider. A rotary encoder can be an electro-mechanical device that converts an angular position or motion of a shaft to an analog or digital code. The roller wheel 60 and rotary encoder 66 can be collectively referred to a rotary wheel and encoder 70.

The mounting base 52 can be coupled to the fifth wheel 30 using a fixed coupling arrangement or a releasable coupling arrangement. For example, the mounting base 52 can be coupled to the fifth wheel 30 with conventional fasteners, quick release mechanisms, and magnetics. It will be appreciated however that the mounting base 52 can be coupled to the fifth wheel 30 by any suitable arrangement.

With continued reference to FIGS. 1-3 and additional reference now to FIG. 4, an exemplary method of using the trailer angle measurement assembly 10 will be described. An exemplary control system 80 configured for use with the trailer angle measurement assembly 10 is shown in FIG. 4. The control system 80 includes a controller 90 that receives a signal 92 from the roller wheel and encoder 70. During use, when the semi-trailer 24 is attached to the fifth wheel 30, the spring 58 presses the roller wheel 60 up against a flat surface 72 of the semi-trailer 24 (see FIG. 2). As the semi-trailer 24 rotates relative to the fifth wheel 30 around a pivot point 76 (FIG. 3) in a direction indicated by arrow 78, the roller wheel 60 is caused to rotate.

The multi-turn potentiometer or rotary encoder 66 measures a rotation of the semi-trailer 24 based on a rotation of the roller wheel 60. The roller wheel and encoder 70 sends the signal 92 having information related to the rotation of the semi-trailer 24 to the controller 90. The controller 90 determines an angular position of the semi-trailer 24 based on the signal 92. In this regard, the controller 90 can translate a rotation measurement of the roller wheel 60 in real time and with sub-degree resolution into an angle 94 (FIG. 3) of the semi-trailer 24. The angle 94 can be an angle that the semi-trailer 24 has relative to the tractor 22.

In some examples, the vehicle 20 can be operated in an autonomous mode. An autonomous mode can be selected in any manner such as by activating a button or switch in the cabin of the tractor 22. In autonomous mode, a vehicle controller can control operation of the vehicle 20. In this regard, the vehicle controller can output signals to control operation of the engine, throttle, brakes, steering and other components of the vehicle 20. The controller 90 can output a signal 98 to the vehicle controller indicative of the trailer angle. Such information can be used to adjust steering and other components of the vehicle 20. For example, when in autonomous mode, the vehicle controller can command the front steer axle 40 to move based on the signal 98 provided by the controller 90.

Returning to FIG. 3, the trailer angle measurement assembly 10 can be mounted at various locations around the fifth wheel 30. In this way, the trailer angle measurement assembly 10 can be mounted in a forward mounting location 110A on the fifth wheel 30, a first side mounting location 1106 on the fifth wheel 30 or on a second side mounting location 110C on the fifth wheel 30.

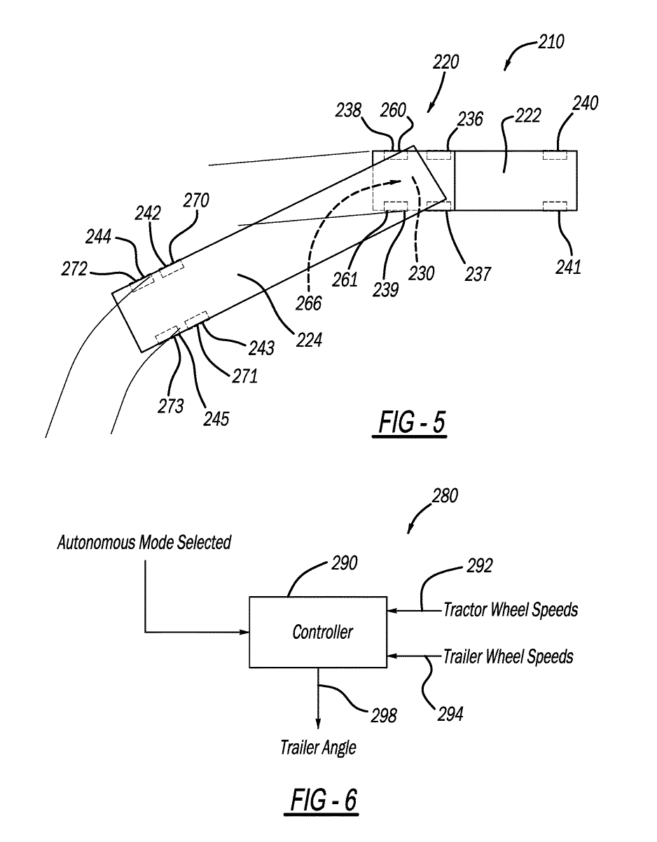

With particular reference now to FIGS. 5 and 6, an exemplary trailer angle measurement assembly constructed in accordance to another example is shown and generally identified at reference numeral 210. As with the exemplary trailer angle measurement assembly 10 described above, the exemplary trailer angle measurement assembly 310 can be particularly suitable for application in a medium-duty or heavy-duty truck. Other vehicles are contemplated. The trailer angle measurement assembly 210 is configured for use in a vehicle 220 having a tractor 222 and a semi-trailer 224. The semi-trailer 224 is selectively coupled to the tractor 222 by a connecting assembly 226 having a fifth wheel 230 fixed to the tractor 222 for selective engagement with a king pin fixed to the semi-trailer 224.

The tractor 222 includes a first left rear wheel 236, a first right rear wheel 237, a second left rear wheel 238 and a second right rear wheel 239. The tractor 222 further includes a left front wheel 240 and a right front wheel 241. The tractor 222 includes a left rear wheel speed sensor 260 and a right rear wheels speed sensor 261. In additional configurations, a front wheel speed sensors may be used on the front wheels 240 and 241 to determine steering angle. The left rear wheel speed sensor 260 is shown configured for use on the second left rear wheel 238, however it can be additionally or alternatively configured for use on the first left rear wheel 236. Similarly, the right rear wheel speed sensor 261 is shown configured for use on the second right rear wheel 239, however it can be additionally or alternatively configured for use on the first right rear wheel 237.

The exemplary tractor 222 is a left-drive tractor 222. In this regard, as used herein “left” is used to refer to a driver side of the tractor 222 while “right” is used to refer to a passenger side of the tractor 222. It is appreciated however that the configuration of the trailer angle measurement assembly 310 is not limited to left-drive tractors and is equally applicable for use with a right-drive tractor 222.

The trailer 224 includes a first left rear wheel 242, a first right rear wheel 243, a second left rear wheel 244 and a second right rear wheel 245. The trailer 224 includes a first left rear wheel speed sensor 270 configured for use with the first left rear wheel 242 and a first right rear wheels speed sensor 271 configured for use with the first right rear wheel 243. The trailer 224 further includes a second left rear wheel speed sensor 272 configured for use with the second left rear wheel 244 and a second right wheel speed sensor 274 configured for use with the second right rear wheel 273.

An exemplary control system 280 configured for use with the trailer angle measurement assembly 210 is shown in FIG. 6. The control system 280 includes a controller 290 that receives a first signal 292 providing tractor wheel speeds from the tractor wheel speed sensors 260 and 261. The controller 290 also receives a second signal 294 providing trailer wheel speeds from the trailer wheel speed sensors 270, 271, 272 and 273. The controller 290 determines a trailer angle based on the first and second signals.

The controller 290 can further determine a difference in wheel speeds (delta) of the tractor 222. In one example, the controller 290 can determine a difference between the left rear wheel speed sensor 260 and a right rear wheels speed sensor 261. Using known geometries of the tractor 222, the controller 290 can determine a tractor radius and a trajectory.

In some examples the controller 290 can also determine a difference in wheel speeds (delta) of the trailer 224. In one example, the controller 290 can determine a difference between the first left rear wheel speed sensor 270 and the first right wheel speed sensor 271. Additionally or alternatively the controller 290 can determine a difference between the second left rear wheel speed sensor 272 and the second right wheel speed sensor 273. Using known geometries of the trailer 224, the controller 290 can determine a trailer radius and a trajectory.

The vehicle 220 can be operated in an autonomous mode. The controller 290 can control operation of the vehicle 220. In this regard, the vehicle controller 290 can output signals to control operation of the engine, throttle, brakes, steering and other components of the vehicle 220. The controller 290 can output a signal 298 to the vehicle controller indicative of trailer angle. Such information can be used to adjust steering and other components of the vehicle 220. For example, when in autonomous mode, the vehicle controller can command the front steer axle to move based on the signal 298 provided by the controller 290.

The relationship between the change in tractor delta and trailer delta provides tractor-trailer position and angle. The controller 290 can therefore utilize absolute wheel speeds, delta wheel speeds and tractor-trailer angle references. Geometry calculations can be used by the controller 290 to predict future locations of the trailer 224 given current conditions. Further, the controller 290 can predict a future change of trailer location given corrective tractor steering changes. The controller 290 can also use current steering angle data and maximum allowable steering angle to determine whether the tractor 222 can recover without a pull-up. A signal can be communicated to the driver (such as on the cluster) indicative of a pull-up requirement.

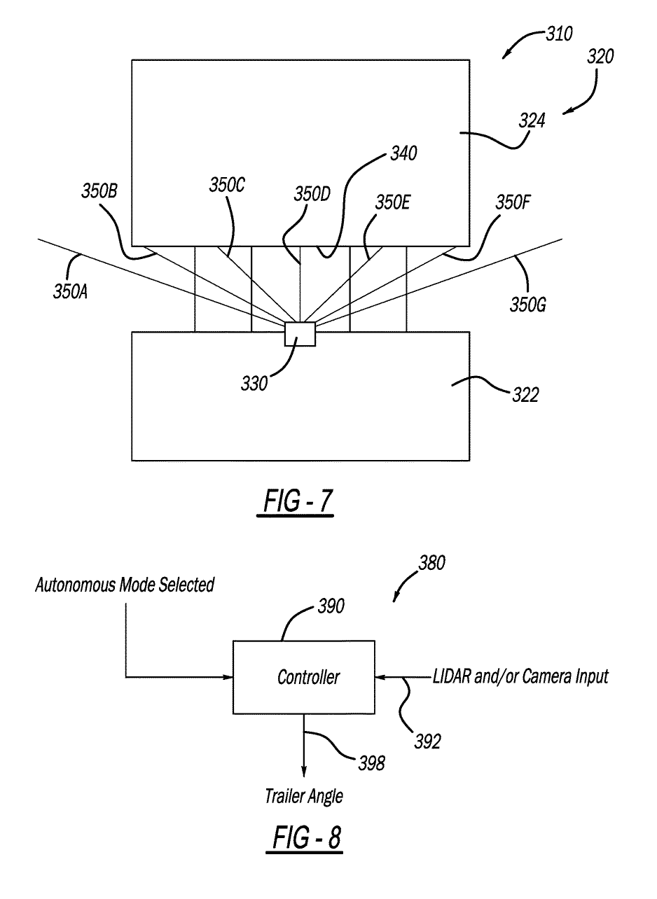

Turning now to FIGS. 7 and 8, an exemplary trailer angle measurement assembly constructed in accordance to another example is shown and generally identified at reference numeral 310. The trailer angle measurement assembly 310 can be suitable for application in a medium-duty or heavy-duty truck. The trailer angle measurement assembly 310 is configured for use in a vehicle 320 having a tractor 322 and a semi-trailer 324. While not particularly shown, the semi-trailer 324 can be coupled to the tractor 322 by a connecting assembly such as described above.

The trailer angle measurement assembly 310 includes an imaging device 330. The imaging device 330 can comprise any device (or combination of devices) suitable to send and or receive light, sound and or image data. In non-limiting examples, the imaging device 330 can comprise a camera or an array of cameras. In other examples, the imaging device 330 can include light detection and ranging (Lidar). In general, Lidar can measure a distance to the trailer 324 by illuminating the trailer 324 with pulsed light and measuring the reflected pulses with a sensor. In one configuration, Lidar can send and receive light beams 350A, 350B, 350C, 350D, 350E, 350F and 350G from the tractor 322 to a surface 340 of the trailer 324. As can be appreciated, as the trailer 324 turns, the length of the light beams 350A, 350B, 350C, 350D, 350E, 350F and 350G will change allowing a controller 390 to determine the distance and/or angle between the tractor 322 and the trailer 324.

An exemplary control system 380 configured for use with the trailer angle measurement assembly 310 is shown in FIG. 8. The control system 380 includes a controller 390 that receives a signal 392 providing information related to the imaging device 330. The controller 390 can use the signal 392 along with known geometries of the tractor 322 and trailer 324 to determine a tractor radius and a trajectory.

The vehicle 320 can be operated in an autonomous mode. The controller 390 can control operation of the vehicle 320. In this regard, the vehicle controller 390 can output signals to control operation of the engine, throttle, brakes, steering and other components of the vehicle 320. The controller 390 can output a signal 398 to the vehicle controller indicative of trailer angle. Such information can be used to adjust steering and other components of the vehicle 320. For example, when in autonomous mode, the vehicle controller can command the front steer axle to move based on the signal 398 provided by the controller 390.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

1. A trailer angle measurement assembly that measures an angle of a trailer relative to a tractor, the trailer angle measurement assembly comprising:
a mounting base configured to be selectively coupled to the trailer;
an armature rotatably coupled to the mounting base around a pivot;
a roller wheel rotatably coupled to the armature and positioned for rotatable engagement with the trailer; and
a rotary encoder that measures rotation of the roller wheel and generates a signal based on the measured rotation indicative of an angular position of the trailer relative to the tractor.

2. The trailer angle measurement assembly of claim 1, further comprising a biasing member that biases the armature toward the trailer.

3. The trailer angle measurement assembly of claim 2 wherein the biasing member is one of a coil spring and leaf spring.

4. The trailer angle measurement assembly of claim 1 wherein the roller wheel is rotatably coupled to a hub of the armature.

5. The trailer angle measurement assembly of claim 1 wherein the mounting base is coupled to a fifth wheel of the trailer.

6. The trailer angle measurement assembly of claim 5 wherein the mounting base is magnetically coupled to the fifth wheel.

7. The trailer angle measurement assembly of claim 5 wherein the mounting base is coupled at a forward mounting location of the fifth wheel.

8. The trailer angle measurement assembly of claim 5 wherein the mounting base is coupled at a side mounting location of the fifth wheel.

9. The trailer angle measurement assembly of claim 1, further comprising a control system having a controller that receives the signal from the rotary encoder.

10. A trailer angle measurement assembly that measures an angle of a trailer relative to a tractor, the trailer angle measurement assembly comprising:
a mounting base configured to be selectively coupled to the trailer;
an armature rotatably coupled to the mounting base around a pivot;
a roller wheel rotatably coupled to the armature and positioned for rotatable engagement with the trailer; and
a potentiometer that measures rotation of the roller wheel and generates a signal based on the measured rotation indicative of an angular position of the trailer relative to the tractor.

11. The trailer angle measurement assembly of claim 10, further comprising a biasing member that biases the armature toward the trailer.

12. The trailer angle measurement assembly of claim 11 wherein the biasing member is one of a coil spring and leaf spring.

13. The trailer angle measurement assembly of claim 10 wherein the roller wheel is rotatably coupled to a hub of the armature.

14. The trailer angle measurement assembly of claim 10 wherein the mounting base is coupled to a fifth wheel of the trailer.

15. The trailer angle measurement assembly of claim 14 wherein the mounting base is magnetically coupled to the fifth wheel.

16. The trailer angle measurement assembly of claim 14 wherein the mounting base is coupled at a forward mounting location of the fifth wheel.

17. The trailer angle measurement assembly of claim 14 wherein the mounting base is coupled at a side mounting location of the fifth wheel.

18. The trailer angle measurement assembly of claim 10, further comprising a control system having a controller that receives the signal from the potentiometer.

19. A method of determining an angular position of a trailer relative to a tractor, the method comprising:
rotatably mounting a roller wheel relative to the tractor;
positioning the roller wheel into rotatable engagement with the trailer;
measuring a rotation of the roller wheel based on the roller wheel rotating from engagement with the trailer; and
determining an angular position of the trailer relative to a tractor based on the measured rotation.

20. The method of claim 19 wherein rotatably mounting the roller wheel relative to the tractor includes magnetically coupling a mounting base to the tractor, the roller wheel coupled to the mounting base through an armature, and wherein magnetically coupling the mounting base to the tractor includes coupling the mounting base to a fifth wheel of the tractor.

21-26. (canceled)
